(19) United States
(12) Patent Application Publication
(10) Pub. No.: US 2021/0042199 A1
(43) Pub. Date: Feb. 11, 2021

(54) SYSTEM AND METHOD OF TRANSFERRING OF DATA BETWEEN DATA CENTERS BASED ON USER BEHAVIOR

(71) Applicant: Acronis International GmbH, Schaffhausen (CH)

(72) Inventors: Hannes Migga-Vierke, Marlborough, MA (US); Serguei Beloussov, Costa Del Sol (SG); Stanislav Protasov, Moscow (RU)

(21) Appl. No.: 16/939,299

(22) Filed: Jul. 27, 2020

Related U.S. Application Data
(60) Provisional application No. 62/883,190, filed on Aug. 6, 2019.

(51) Int. Cl. G06F 11/14; H04L 29/06

(52) U.S. Cl. CPC G06F 11/1469; G06F 11/1464; G06F 2201/805; H04L 63/0272; G06F 11/1451; G06F 11/1461

(57) ABSTRACT

Disclosed herein are systems and methods for fast recovery of backup data. In one aspect, an exemplary method comprises, identifying information related to a computing device performing a backup, identifying a data center where the backup is stored based on the information, identifying patterns of movement of the computing device over a period of time, scheduling a transfer of the backup to a target data center of a plurality of data centers based on the patterns of movement, and transferring the backup to the data center using a secure reliable transport protocol in accordance with the scheduled transfer.

### CROSS-REFERENCE TO RELATED APPLICATIONS

This application claims the benefit of U.S. Provisional Application No. 62/883,190, filed Aug. 6, 2019, which is herein incorporated by reference.

### FIELD OF TECHNOLOGY

The present disclosure relates generally to the field of data backup and retrieval, and more specifically, to systems and method of transferring data between data centers based on user behavior.

### BACKGROUND

Business users travel often to various destinations for business or pleasure and need data to be available instantly for whatever tasks must be performed. Generally, user data is backed up on servers that are closest to the computing device, so when users are in their home office, data centers that are close to that location are used for backup and transfer of data.

Often, business users need to access important presentations, documents, agreements, or the like, quickly. However, if the user moves his or her device often, then it may take longer to retrieve backed up user data or even profile data that is stored at a data center in a different geographical region. Therefore, there is a need in the art to quickly and efficiently replicate user data across data centers to allow the fast retrieval of user data from wherever the user is located.

### SUMMARY

Aspects of the disclosure relate to the field of computer security, and more specifically to systems and methods for fast recovery of backup data.

In an exemplary aspect, the method may identify information related to a computing device performing a backup, the information comprising geographic information, network information, and user behavior of a user associated with the computing device. The method may identify a first data center where the backup is stored based on the information. The method may identify patterns of movement of the computing device over a period of time and respective distances between the computing device and a plurality of data centers. The method may then schedule, subsequent to the period of time, a transfer of the backup from the first data center to a second data center of the plurality of data centers based on the patterns of movement. The method may transfer the backup to the second data center using a secure reliable transport protocol in accordance with the scheduled transfer.

In some aspects, the method may schedule the transfer of the backup to the second data center by determining that the computing device was at a location at a first time in the period of time. The method may predict that the computing device will be at the location at a second time subsequent to the period of time. In response to determining that (1) the first data center is more a threshold distance away from the location and (2) the second data center of the plurality of data centers is within the threshold distance to the location, the method may schedule the transfer.

In some aspects, the method may schedule the transfer to occur prior to the second time such that data in the backup is available for access from the second data center at the second time.

In some aspects, the period of time is reoccurring (e.g., every week, day, month, year, etc.) and the first time corresponds to the second time. Accordingly, the method may predict that the computing device will be at the location at the second time by determining that computing device was present at the location for at least a threshold number of times during the first time.

In some aspects, the method may schedule the transfer of the backup to the second data center by determining that at least two data centers of the plurality of data centers are within the threshold distance from the location, wherein the at least two data centers includes the second data center. The method may then select the second data center from the at least two data centers for transferring the backup in response to determining that a communication latency between the computing device and the second data center is lower than communication latencies between the computing device and the remaining data centers of the at least two data centers.

In some aspects, the method may replicate the backup between the first data center and the second data center.

In some aspects, the method may determine that the computing device is using a virtual private network, and may delay the backup until the computing device is connected to a faster network.

In some aspects, the computing device is connected to the VPN over a mobile network.

In some aspects, the secure reliable transport protocol is Synology Internet Transfer Accelerator (SITA).

In some aspects, the second data center comprises a prior backup of the computing device. Accordingly, the method may determine a difference between the backup and prior backup in the second data center, and may transfer only the difference to the second data center.

It should be noted that the methods described above may be implemented in a system comprising a hardware processor. Alternatively, the methods may be implemented using computer executable instructions of a non-transitory computer readable medium.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram of a system of transferring data between data centers based on user behavior, in accordance with exemplary aspects of the present disclosure.

FIG. 2 is a block diagram of the fast transfer module, in accordance with exemplary aspects of the disclosure.

FIG. 3 is another block diagram illustrating operation of the fast transfer module, according to exemplary aspects of the present disclosure.

FIG. 4 is a flowchart illustrating a method of transferring data between data centers based on user behavior, in accordance with exemplary aspects of the present disclosure.

FIG. 5 is a flowchart illustrating a method of transferring data between data centers based on user behavior, in accordance with exemplary aspects of the present disclosure.

FIG. 6 is a block diagram of a computer system on which the disclosed system and method can be implemented according to an exemplary aspect.

### DETAILED DESCRIPTION

Exemplary aspects are described herein in the context of a system, method, and computer program product of transferring data between data centers based on user behavior. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

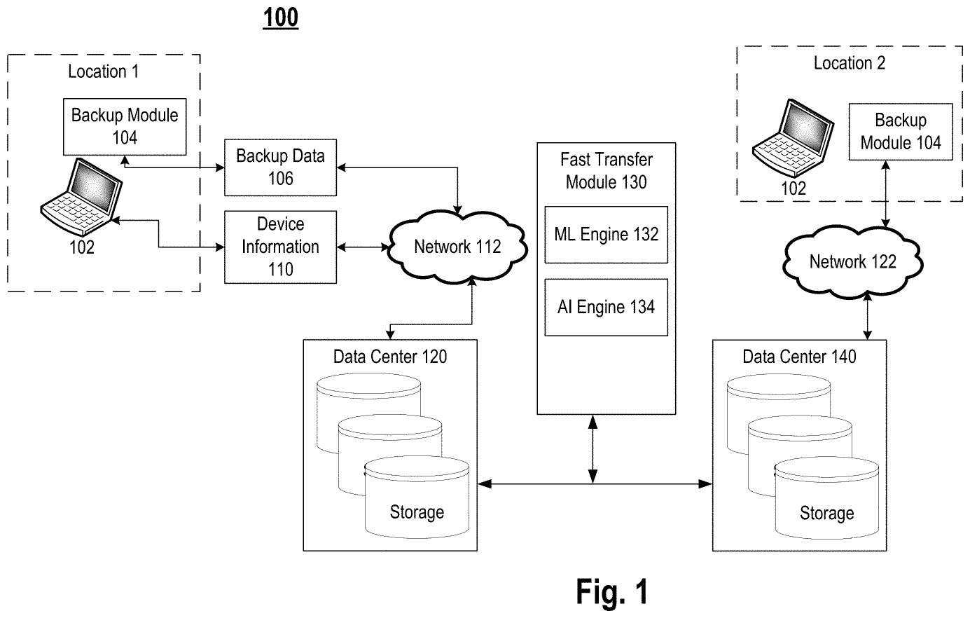

FIG. 1 is an block diagram of a system 100 of transferring data between data centers based on user behavior, in accordance with exemplary aspects of the present disclosure.

The system 100 comprises a client computing device 102, a fast transfer module 130, data center 120 and data center 140. In exemplary aspects, the system 100 may comprise a plurality of data centers in various locations.

The client computing device 102 may be any type of mobile computing device that a user can transport to various locations within a building, a country or internationally. The computing device 102 may be a laptop computer, a tablet computer, a mobile device or the like. The computing device 102 may change locations on a regular basis, for example from location 1 to location 2 shown in FIG. 1 The computing device 102 also includes a backup module 104 that performs a backup of user data stored on the computing device 102, wherein the user data may be a large dataset that takes significant time to retrieve. The backup module 104 may also retrieve data that is not stored locally at the computing device 102, wherever the computing device 102 is located. In exemplary aspects, the backup module 104 stores and/or retrieves user data from the data center where the user data is stored. At times, this may be data center 120 while at other times, this may be data center 140 or another data center associated with the computing device 102.

Each data center is located in a particular physical location, extending data storage and backup coverage to a particular geographic region. The data centers have multiple storage devices for redundancy and data storage of user data as well as other backup data such as snapshots, backup images and the like. At some point, when computing devices are outside of the geographic coverage region of a data center, it may take less time to retrieve user data from another data center. However, often data is not duplicated across data centers, or the data is not available at other data centers when it is required by a user. In aspects of the present disclosure, as the computing device 102 changes locations, data centers in the same geographic location can provide the user data required by the user, without involvement from the user of the computing device 102, creating a seamless transition from one location to the next.

In exemplary aspects, the computing device 102 is at location 1 first and backs up/retrieves/accesses user data from the data center 120 within its geographic region via network 112. For simplicity, the geographic region can be represented as a circle with a radius that extends to a threshold distance (e.g., 500 meters). However, one skilled in the art will appreciate the geographic region can be any boundary (of any shape) within which data center 120 provides various services (e.g., data retrieval, synchronization, upload, etc.) at a predetermined quality of service (e.g., minimum communication latency, maximum packet drop threshold, etc.). It should be noted that when a computing device leaves the geographic region of a data center, quality of service offered to the computing device by the data center decreases relative to distance (e.g., exponentially, linearly, etc.). For example, the communication latency may increase five times as much when the computing device is at the threshold distance from the data center when the computing device is 5 meters outside of the geographic region.

In some aspects, the data center 120 is the “home,” “master”, or “first” data center, i.e., the primary data center used by the computing device 102 to store backups of user data, snapshots, images and the like. In some aspects, the backup data 106 is stored at the data center 120, along with device information 110. The device information 110 may include geographic information where the computing device 102 is located, information about hardware and software installed on the device 102, information about the backup data 106, i.e., type, frequency of backup, importance, and the like. Geographic information can be determining using GPS, GPRS and/or other location services. Device information 110 may also include information about the network 112 and how the device 102 is connected to the network 112, speed of segments along the network 112 as well as latency between the data center and the computing device 102 and other related network information. Additional device information may include user behavior and interaction with the backup data 106 and with the master data center such as frequency of use of documents, frequency of backups and retrievals and the like.

The system 100 also includes a fast transfer module 130 that observes location changes of the computing device 102 stored in the data center 120 as specified in the device information 110 and allows the data to “follow” the user based on current network environment and user behavior. Over time, the data center 120 will hold a historical track record of locations that the computing device 102 has operated from, in addition to associated network conditions and user behavior. The fast transfer module 130 analyzes the historical information stored in data center 120 and transfers or redistributes backup data 106 to a different data center depending on the changed location of the computing device 102. For example, if the computing device 102 is relocated to location 2, the fast transfer module 130 may determine that the closest data center in the geographical region is data center 140. Thus the backup data 106 is transferred and/or replicated to the data center 140. Accordingly, the backup module 104 can access the backup data 106 from the data center 140 via network 122 with significantly less delay than accessing the backup data 106 stored in data center 120.

In exemplary aspects, the fast transfer module 130 determines the best data center to used based on a host of information, for example, by computing a distance between the data center and the location of the computing device 102. In one aspect, this distance is calculated by determining the number of hops between the computing device 102 and several data centers, and selecting the data center based on a combination of the lowest number of hops, the speed of the data center, the optimization of the data center, and the availability of the data center. The data is replicated across the data centers using a fast, secure and reliable transport protocol such as Synology Internet Transfer Accelerator (SITA) or others. In some aspect, a custom protocol is contemplated to reduce waiting time between block transfers, combined with advanced stream compression like Burrows-Wheeler transform (BWT) for block sorting prior to compression. In some aspects, the protocol may support backup difference capabilities of archival formats such as Archive3 to transfer data to data centers. Therefore the data “follows” a user and/or computing device 102 as the user or computing device travels from location to location.

The fast transfer module 130 may also analyze the historical records to extract patterns of movement of the computing device 102. Using these patterns the fast transfer module 130 may predict the location of the computing device 102 in the future, and replicate the backup data 106 from data center 120, or data center 140, to other data centers that are nearest to the predicted location of the computing device 102.

For example, in some instances a user may take regular business flights from New York City to Singapore, stay in Singapore from Monday to Thursday, and return to New York City until Sunday. In some aspects, the user allows the backup module 104 permissions to access location information to save to the data center 120. This location information is observed by the fast transfer module 130 for several weeks, months or any predetermined time period. Once the fast transfer module 130 makes the observation that this travel route is regularly occurring scheduled travel, the fast transfer module 130 arranges for the replication of the data from the master data center, e.g., data center 120 to the data center closest to the Singapore region, data center 140 for example, on a regular basis prior to travel. Additionally, if further destinations are visited often enough, a pattern may emerge as recognized by the Al engine 132, allowing the fast transfer module 130 to replicate the data accordingly to different data centers and partner data centers.

In some aspects, if the user is in, for example, a hotel room, the backup module 104 can determine whether the computing device 102 is using a virtual private network (VPN), e.g., over a mobile network. The backup module 104 may then delay the backup until the computing device is connected to a faster network, or when the user has logged off the VPN. Often, in this example the data is already encrypted, therefore performing the backup outside of the VPN is still secure, yet faster because there are no additional round trips that packets of the backup data 106 must endure to reach the appropriate data canter. At a general level, the Al engine 134 of the fast transfer module 130 may be used by the backup module 104 to predict a schedule for backup scattering over a period of time based on user location (e.g., hotel, airport, etc.). In some aspects, the user can grant the backup module 104 access to a calendar application to extract user schedules and schedule the backups/transfers accordingly.

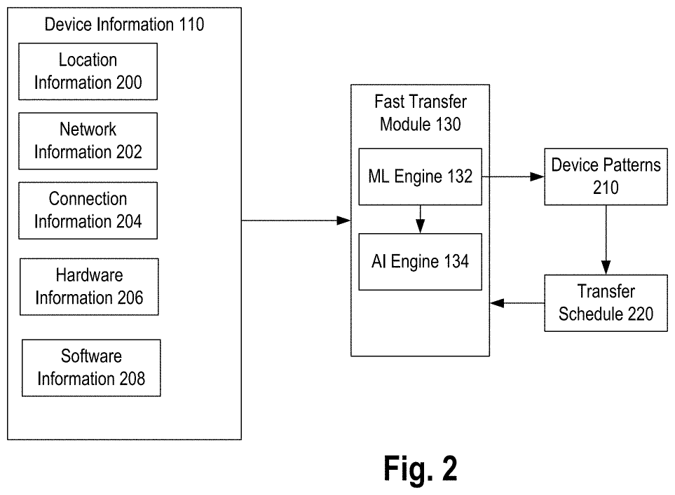

FIG. 2 is a block diagram of the fast transfer module 130, in accordance with exemplary aspects of the disclosure.

In exemplary aspects, the fast transfer module 130 receives or retrieves the device information 110, either through the data center 120 or directly from the backup module 104. In some aspects, the device information 110 includes location information 200, network information 202, connection information 204, hardware information 206 and software information 208. As described above, location information 200 includes geographic details regarding the location of the user/computing device 102 along with, in some aspects, motion data or the like. Additional sensory readings may also be stored in the location information 200. In some aspects, the location information 200 is obtained via GPS module at the computing device, or other various geo-location techniques.

The network information 202 may include network key performance indicators (KPIs), including the type network the computing device 102 is connected to locally, the type of wide area network the computing device 102 is using, speed of the network, security of the network, segments within the network, network latency, bandwidth and the like. The connection information 204 may include how the computing device 102 is connected to the network, i.e., which protocol, type of connection, or the like. Hardware information 206 includes hardware details about the computing device 102 and the network hardware. In some aspects, software information 208 includes information about software installed on the device 102, including operating system software, installed applications, versions of applications and software, and the like.

The fast transfer module 130 takes all of this device information into consideration. The ML engine 132 then extracts device patterns 210 from the device information 110. The patterns could be either individual patterns, e.g., location patterns, network patterns, connection patterns, hardware and software patterns. Using the Al engine 134, one or more transfer schedules 220 are generated that indicate when and under what conditions a data backup should be replicated/transferred from one data center to another data center. The transfer schedule may indicate a time period as well as network conditions, location conditions and may specify which particular data centers to transfer to, and/or the considerations when selecting the target data center. For example, the transfer schedule 220 may specify that only data centers that have a response time greater than a threshold degree should be used. In another example, only those data centers that can be accessed within a certain number of hops from the computing device should be used. The transfer schedule 220 is applied in the background by the fast transfer module 130 so the computing device 102 is able to access user data wherever the device is located in a fast and efficient manner, with high reliability. Further, in some aspects the Al engine 134 may suggest new data centers or storage centers based on user movement in order to add more geographic coverage to the system 100 so that a user can retrieve data fast from anywhere in the world.

In some aspects, the fast transfer module 130 only transfers a portion of backup data 106 based on the type of data that will be accessed at a particular location. For example, the user may travel to his office, triggering a transfer of data from data center 120 to data center 140, wherein the office is within the geographic region of data center 140. However, rather than transferring the backup data 106 in its entirety to data center 140, the fast transfer module 130 analyzes the files in backup data 106 that the user has historically used at the office. For example, the user may have accessed files from a particular directory in backup data 106 at least a predetermined number of times within the period of time (e.g., 5 times at the office within a week). Accordingly, the fast transfer module 130 may identify the accessed files (possibly their updated versions) for transfer.

In further aspects of the disclosure, the Al engine 134 may observe data transfers between data centers that occur regularly when a user relocates, and extract movement patterns based on the movement of data as opposed to movement of the location of the computing device 102. In yet other aspects, the Al engine 134 may observe data stored in the data center 120, for example, to identify an “endpoint”, e.g., a computing device based on similarities of the recorded device information when a computing device 102 is not explicitly specified in the data. Further, instead of identifying an endpoint, a user can be identified by the Al engine 134 when multiple endpoint data is similar in nature, whereas similarity is determined based on known methods of computing similarity between a set of attributes or data points. Based on identifying a user or an endpoint, patterns are then extracted and a transfer schedule created.

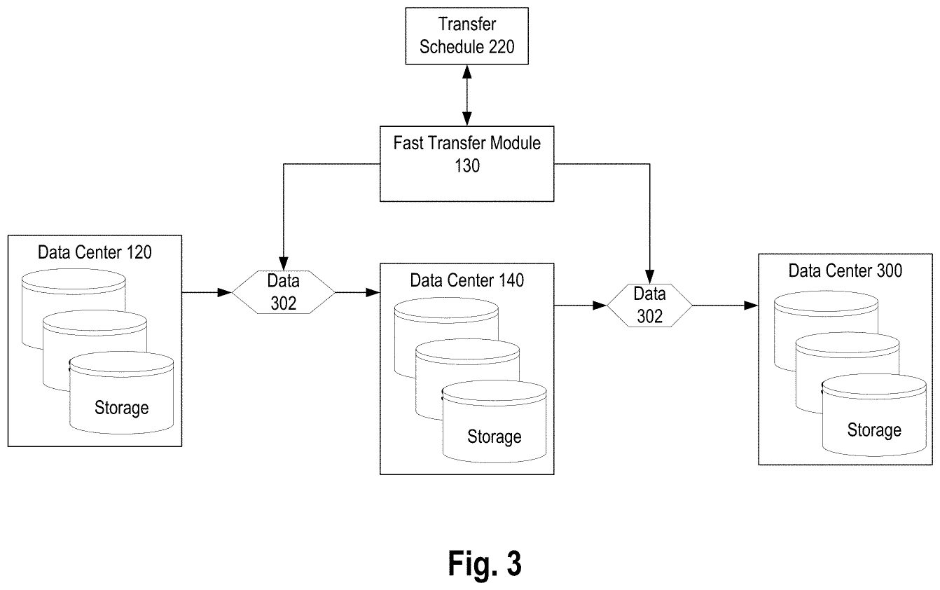

FIG. 3 is another block diagram illustrating operation of the fast transfer module 130, according to exemplary aspects of the present disclosure.

Given the transfer schedule 220, the fast transfer module 130 is able to schedule transmission and/or replication of data 302 between data center 120, data center 140 and data center 300. In exemplary aspects, the data that is transferred is merely the difference between the data already stored and the data being transferred in order to reduce the consumption of resources by many transfers. In some aspects, the data center 120 may be the primary data center, while data center 30 is only a secondary or tertiary data center, and therefore the data may be biased so that the fast transfer module 130 always performs a differential backup to the data center 120 (i.e., the primary data center) prior to replication to other data centers. While this may incur a slight overhead cost, the fast transfer module 130 then ensures that data stored in the primary data center used by the computing device 102 is always available for the user to access.

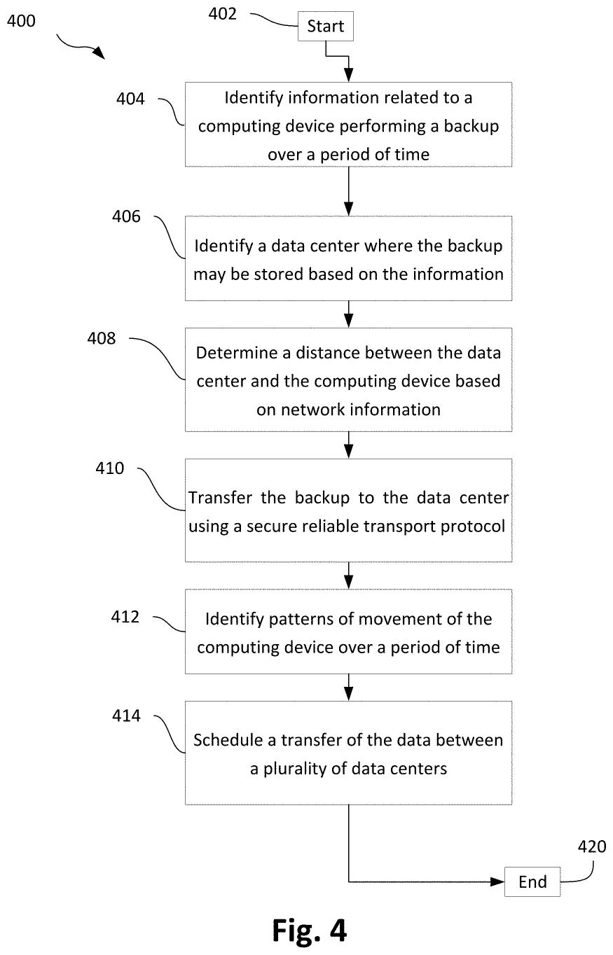

FIG. 4 is a flowchart illustrating a method of transferring data between data centers based on user behavior, in accordance with exemplary aspects of the present disclosure.

The method begins at 402 and proceeds to 404.

At 404, the fast transfer module 130 identifies information related to a computing device performing a backup over a period of time, the information comprising geographic information, network information and user behavior of a user associated with the computing device. The information may be obtained via the backup module 104 of a device, and may include hardware/software information, sensor information such as GPS and the like, along with connected network information such as latency, bandwidth, speed and the like.

At 406, the fast transfer module 130 identifies a data center where the backup may be stored based on the information. This may include a known primary data center, or the closest data center to the device/endpoint.

At 408, the fast transfer module 130 determines a distance between the data center and the computing device based on network information. This may include the number of hops between the device and the data center, along with consideration for the speed, availability and storage space of the data center, though other considerations are also contemplated herein.

At 410, the fast transfer module 130 transfers the backup to the data center using a secure reliable transport protocol. The transport protocol may be SITA or the like, but must ensure reliable and secure transfer of data.

At 412, the fast transfer module 130 identifies patterns of movement of the computing device over a period of time. The patterns of movement may be identified by artificial intelligence and may commence after a certain amount of data is available in the data center from which conclusions regarding future locations can be predicted.

At 414, the fast transfer module 130 schedules a transfer of the data between a plurality of data centers based on the patterns of movement and the collected information related to the computing device over the period of time. The data may be scheduled to be transferred from a primary data center, to one or more secondary servers. In some aspects, only differential data is transferred where the secondary servers may already contain some of the backup data that a user may request from a different location.

At 420, the method terminates.

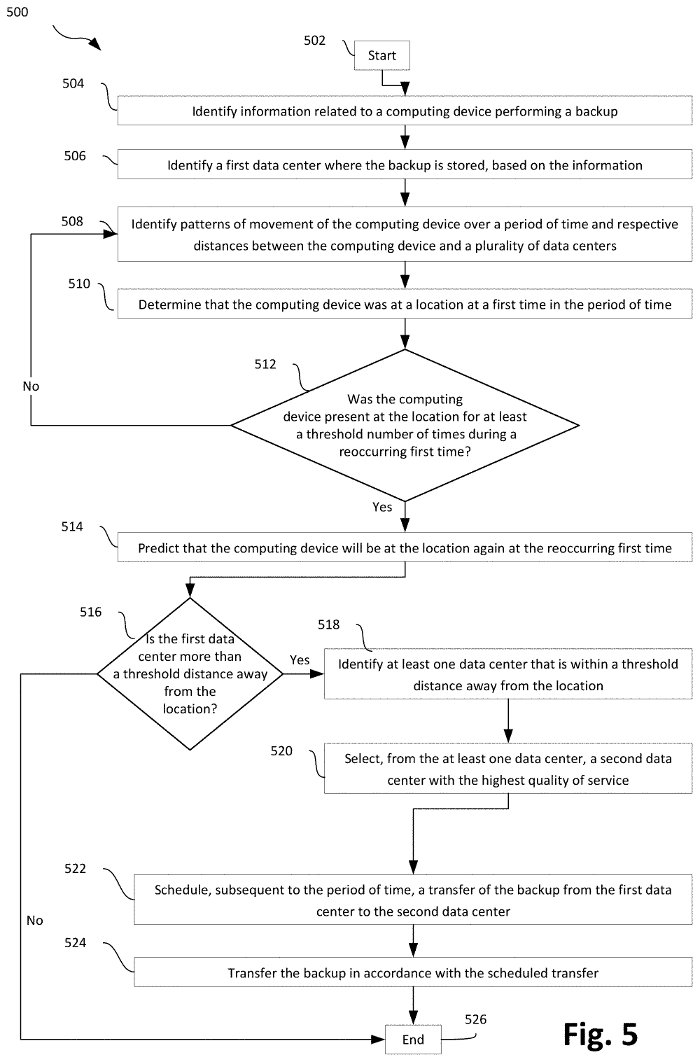

FIG. 5 is a flowchart illustrating method 500 of transferring data between data centers based on user behavior, in accordance with exemplary aspects of the present disclosure.

The method 500 begins at 502 and proceeds to 504.

At 504, the fast transfer module 130 identifies information related to a computing device (e.g., computing device 102) performing a backup (e.g., comprising backup data 106). At 506, the fast transfer module 130 identifies a first data center where the backup is stored, based on the information. For example, the backup data 106 may be stored in data center 120. At 508, the fast transfer module 130 identifies patterns of movement of the computing device over a period of time and respective distances between the computing device and a plurality of data centers. For example, the fast transfer module 130 may monitor the locations of computing device 102 over the course of a day or a week. During this time, the fast transfer module 130 may analyze where computing device 102 moves (e.g., from a location such as a house to a location such as an office via route including a highway). As computing device 102 moves to different locations and stays at the location for a minimum amount of time such as 5 minutes, the fast transfer module 130 may calculate the distance between the computing device 102 and a plurality of data centers.

At 510, the fast transfer module 130 determines that the computing device was at a location at a first time in the period of time. For example, the fast transfer module 130 may determine that on Monday at 10:00 am, the computing device 102 certain GPS coordinates associated with the device user's office. Based on the GPS coordinates, the fast transfer module 130 may assign a location (i.e., the location) to the computing device 102. At 512, the fast transfer module 130 determines whether the computing device was present at the location for at least a threshold number of times during a reoccurring first time. For example, during the period of one week, 10:00 am reoccurs 7 times—once each day. The fast transfer module 130 may determine whether the computing device 102 was at the location at least 5 of the 7 times (e.g., at the office on weekdays).

In response to determining that the computing device was not present at the location for at least a threshold number of times, method 500 returns to 508. In response to determining that the computing device was present at the location for at least a threshold number of times, method 500 proceeds to 514, where the fast transfer module 130 predicts that the computing device will be at the location again at the reoccurring first time. For example, because the user was at the location (e.g., the office) 5 of 7 times in the week, the fast transfer module 130 may determine that the computing device 102 will return to the office on Monday 10:00 am after the period of time (i.e., the following week).

At 516, the fast transfer module 130 determines whether the first data center is more than a threshold distance away from the location. For example, the fast transfer module 130 may determine whether the first data center where the backup data 106 is stored is more than 50 kilometers away from the location (e.g., the office). In response to determining that the first data center is more than a threshold distance away from the location, method 500 proceeds to identify at least one data center that is within a threshold distance away from the location. Otherwise (i.e., the first data center is within range of the location and can adequately provide services to the computing device), method 500 ends at 526. In this example, 50 kilometers may represent the geographic region within which the first data center (or any data center) provides more than a minimum quality of service. In response to determining that the distance is greater than 50 km, the fast transfer module 130 determines that another data center that has a geographic range within which the location falls is more appropriate for holding backup data 106. For simplicity, suppose that all of the plurality of data centers have a geographic range expanding the same threshold distance (e.g., 50 km). Accordingly, the fast transfer module 130 determines whether there is another data center that is less than 50 km away from the location. One skilled in the art will appreciate that each data center may expand over a larger or smaller geographic region depending on the characteristics of the geography (i.e., whether there are several obstacles such as buildings, forests, mountains in the way) and the amount of signal traffic in the area causing signal interferences. Accordingly, the fast transfer module 130 may also identify the nearest data centers to the location and evaluate whether the location is within the unique geographic range of the data center.

At 520, the fast transfer module 130 selects, from the at least one data center, a second data center with the highest quality of service (e.g., lowest communication latency, least amount of packet drops, lowest signal to noise ratio, etc.). For example, multiple data centers may be viable candidates (in terms of distance) and the fast transfer module 130 may select the best data center based on criteria such as latency, packet drops, noise ratio, etc.) At 522, the fast transfer module 130 schedules, subsequent to the period of time, a transfer of the backup from the first data center to the second data center. For example, the fast transfer module 130 may determine that because the second data center will provide a better quality of service than the first data center, a transfer is scheduled at a time subsequent to the period of time. It should be noted that the transfer is scheduled such that the backup data 106 is readily available for access by the computing device at the second data center that 10:00 am on Monday. At 524, the fast transfer module 130 transfers the backup in accordance with the scheduled transfer. Subsequently, method 500 ends at 526.

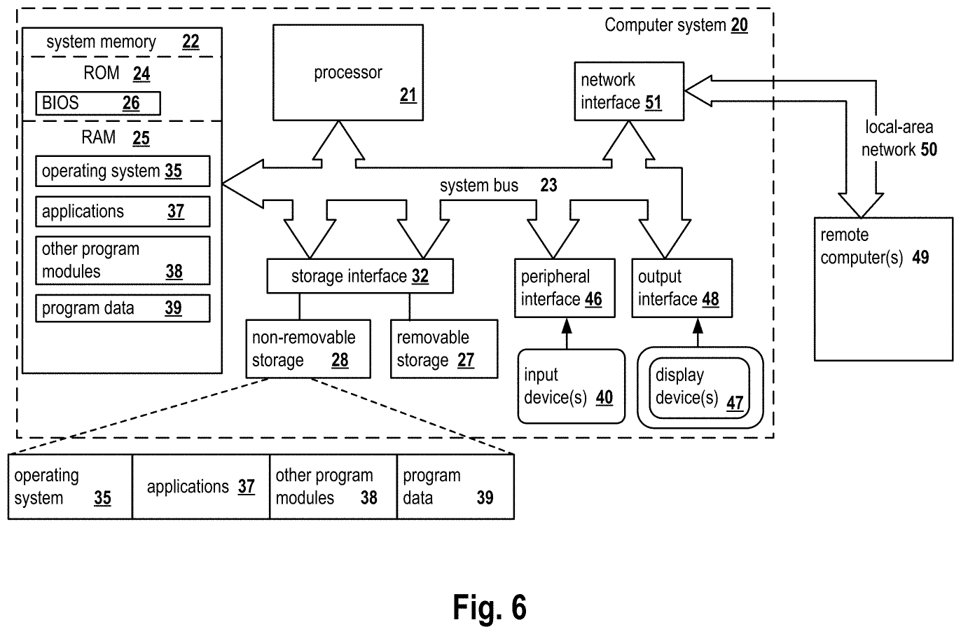

FIG. 6 is a block diagram illustrating a computer system 20 on which aspects of systems and methods of transferring data between data centers based on user behavior may be implemented in accordance with an exemplary aspect. It should be noted that the computer system 20 can correspond to any components of the system 100 described earlier. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable codes implementing the techniques of the present disclosure. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computer system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some aspects, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system (such as the one described in greater detail in FIG. 6, above). Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed is:

1. A method of fast recovery of backup data, the method comprising:
identifying information related to a computing device performing a backup, the information comprising geographic information, network information, and user behavior of a user associated with the computing device;
identifying a first data center where the backup is stored based on the information;
identifying patterns of movement of the computing device over a period of time and respective distances between the computing device and a plurality of data centers;
predicting a location of the computing device subsequent to the period of time based on the patterns of movement;
in response to determining that a second data center of the plurality of data centers is closer to the location than the first data center, scheduling, subsequent to the period of time, a transfer of the backup from the first data center to the second data center; and
transferring the backup to the second data center using a secure reliable transport protocol in accordance with the scheduled transfer.

2. The method of claim 1, wherein scheduling the transfer of the backup to the second data center further comprises:
determining that the computing device was at the location at a first time in the period of time;
predicting that the computing device will be at the location at a second time subsequent to the period of time; and
in response to determining that (1) the first data center is more a threshold distance away from the location and (2) the second data center of the plurality of data centers is within the threshold distance to the location, scheduling the transfer.

3. The method of claim 2, further comprising scheduling the transfer to occur prior to the second time such that data in the backup is available for access from the second data center at the second time.

4. The method of claim 2, wherein the period of time is reoccurring, wherein the first time corresponds to the second time, and wherein predicting that the computing device will be at the location at the second time comprises determining that computing device was present at the location for at least a threshold number of times during the first time.

5. The method of claim 2, wherein scheduling the transfer of the backup to the second data center further comprises:
determining that at least two data centers of the plurality of data centers are within the threshold distance from the location, wherein the at least two data centers includes the second data center; and
selecting the second data center from the at least two data centers for transferring the backup in response to determining that a communication latency between the computing device and the second data center is lower than communication latencies between the computing device and the remaining data centers of the at least two data centers.

6. The method of claim 1, further comprising:
replicating the backup between the first data center and the second data center.

7. The method of claim 1, further comprising:
determining that the computing device is using a virtual private network; and
delaying the backup until the computing device is connected to a faster network.

8. The method of claim 7, wherein the computing device is connected to the VPN over a mobile network.

9. The method of claim 1, wherein the secure reliable transport protocol is Synology Internet Transfer Accelerator (SITA).

10. The method of claim 1, wherein the second data center comprises a prior backup of the computing device, further comprising:
determining a difference between the backup and prior backup in the second data center; and
transferring only the difference to the second data center.

11. A system of fast recovery of backup data, the system comprising:
a hardware processor configured to:
identify information related to a computing device performing a backup, the information comprising geographic information, network information, and user behavior of a user associated with the computing device;
identify a first data center where the backup is stored based on the information;
identify patterns of movement of the computing device over a period of time and respective distances between the computing device and a plurality of data centers;
predict a location of the computing device subsequent to the period of time based on the patterns of movement;
in response to determining that a second data center of the plurality of data centers is closer to the location than the first data center, schedule, subsequent to the period of time, a transfer of the backup from the first data center to the second data center; and
transfer the backup to the second data center using a secure reliable transport protocol in accordance with the scheduled transfer.

12. The system of claim 11, wherein the hardware processor is configured to schedule the transfer of the backup to the second data center by:
determining that the computing device was at the location at a first time in the period of time;
predicting that the computing device will be at the location at a second time subsequent to the period of time; and
in response to determining that (1) the first data center is more a threshold distance away from the location and (2) the second data center of the plurality of data centers is within the threshold distance to the location, scheduling the transfer.

13. The system of claim 12, wherein the hardware processor is further configured to schedule the transfer to occur prior to the second time such that data in the backup is available for access from the second data center at the second time.

14. The system of claim 12, wherein the period of time is reoccurring, wherein the first time corresponds to the second time, and wherein the hardware processor is configured to predict that the computing device will be at the location at the second time by determining that computing device was present at the location for at least a threshold number of times during the first time.

15. The system of claim 12, wherein the hardware processor is configured to schedule the transfer of the backup to the second data center by:
determining that at least two data centers of the plurality of data centers are within the threshold distance from the location, wherein the at least two data centers includes the second data center; and
selecting the second data center from the at least two data centers for transferring the backup in response to determining that a communication latency between the computing device and the second data center is lower than communication latencies between the computing device and the remaining data centers of the at least two data centers.

16. The system of claim 11, wherein the hardware processor is further configured to replicate the backup between the first data center and the second data center.

17. The system of claim 11, wherein the hardware processor is further configured to:
determine that the computing device is using a virtual private network; and
delay the backup until the computing device is connected to a faster network.

18. The system of claim 17, wherein the computing device is connected to the VPN over a mobile network.

19. The system of claim 11, wherein the secure reliable transport protocol is Synology Internet Transfer Accelerator (SITA).

20. A non-transitory computer readable medium storing thereon computer executable instructions for fast recovery of backup data, including instructions for:
identifying information related to a computing device performing a backup, the information comprising geographic information, network information, and user behavior of a user associated with the computing device;
identifying a first data center where the backup is stored based on the information;
identifying patterns of movement of the computing device over a period of time and respective distances between the computing device and a plurality of data centers;
predicting a location of the computing device subsequent to the period of time based on the patterns of movement;
in response to determining that a second data center of the plurality of data centers is closer to the location than the first data center, scheduling, subsequent to the period of time, a transfer of the backup from the first data center to the second data center; and
transferring the backup to the second data center using a secure reliable transport protocol in accordance with the scheduled transfer.
